(19) United States
(12) Patent Application Publication
(10) Pub. No.: US 2009/0104172 A1
(43) Pub. Date: Apr. 23, 2009

(54) METHODS FOR KILLING SPORES AND DISINFECTING OR STERILIZING DEVICES

(75) Inventors: Bjoern Eggert Christensen, Bagsvaerd (DK); Marie Allesen-Holm, Hilleroed (DK); Steffen Danielsen, Copenhagen Oe (DK); Morten Gjermansen, Greve (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 12/256,866

(22) Filed: Oct. 23, 2008

Related U.S. Application Data
(60) Provisional application No. 60/989,491, filed on Nov. 21, 2007.

(30) Foreign Application Priority Data
Oct. 23, 2007 (EP) 07119126.6

(51) Int. Cl. A01N 63/00

(52) U.S. Cl. 424/94.4

(57) ABSTRACT

The present invention provides a method for killing or inactivating spores, by contacting the spores with a haloperoxidase, hydrogen peroxide, chloride or bromide ions, and ammonium ions.

### CROSS-REFERENCE TO RELATED APPLICATIONS

This application claims priority or the benefit under 35 U.S.C. 119 of European application no. 07119126.6 filed Oct. 23, 2007 and U.S. provisional application No. 60/989,491 filed Nov. 21, 2007, the contents of which are fully incorporated herein by reference.

### FIELD OF THE INVENTION

The present invention relates to enzymatic methods for killing or inactivating microbial spores, and for disinfecting or sterilizing devices and equipment.

### BACKGROUND OF THE INVENTION

Spores are known to form from aerobic Bacilli, anaerobic Clostridia, selected sarcinae and a few actinomycetes. Spores resemble certain plant seeds in that they do not carry out any metabolic reactions. In this regard they are especially suited to withstand severe environmental stress and are known to survive prolonged exposures to heat, drying, radiation and toxic chemicals. These properties make spores especially difficult to kill in environments, like living tissue or objects which come in contact with living tissue, which would be adversely effected by extreme conditions.

Fungi, viruses and vegetative cells of pathogenic bacteria are sterilized within minutes at 70 degrees Celsius; many spores are sterilized at 100 degrees Celsius. However, the spores of some saprophytes can survive boiling for hours. Heat is presently the most commonly used means to ensure sterilization of spores.

The outer coat of spores is made of a keratin-like protein which comprises as much as 80% of the total protein of the spore. It is this protein coat which is responsible for the resistance of spores to chemical sterilizing agents. The spore stage of the microbial life cycle is characterized by metabolic dormancy and resistance to environmental factors that would destroy the microbe in its vegetative stage.

Germination of bacterial endospores and fungal spores is associated with increased metabolism and decreased resistance to heat and chemical reactants. For germination to occur, the spore must sense that the environment is adequate to support vegetation and reproduction. Simple alpha amino acids may stimulate spore germination.

EP 500 387 discloses enzymatic antimicrobial compositions comprising a haloperoxidase, e.g., myelo-peroxidase, eosinophil oxidase, lactoperoxidase and chloroperoxidase, which selectively binds to and inhibits the growth of target microorganisms in the presence of peroxide and halide.

WO 95/27046 discloses an antimicrobial composition comprising a vanadium chloroperoxidase, halide ions, and hydrogen peroxide or a hydrogen peroxide-generating agent.

WO 96/38548 discloses an antimicrobial composition comprising a haloperoxidase, a halide ion, a peroxide generating agent and an amino acid type.

The present invention provides an improved enzymatic method for killing or inactivating spores.

### SUMMARY OF THE INVENTION

The present invention provides a method for killing or inactivating microbial spores, comprising contacting the spores with a haloperoxidase, a source of hydrogen peroxide, a source of chloride and/or bromide ions, and a source of ammonium ions.

In another aspect, the invention provides a method for disinfecting or sterilizing a device, preferably a medical device, comprising contacting the device with a haloperoxidase, hydrogen peroxide, chloride and/or bromide ions, and ammonium ions.

In an embodiment, the haloperoxidase is a chloroperoxidase or a bromoperoxidase. In another embodiment the haloperoxidase is a vanadium containing haloperoxidase.

### DETAILED DESCRIPTION OF THE INVENTION

### Haloperoxidases and Compounds Exhibiting Haloperoxidase Activity

The haloperoxidases suitable for being incorporated in the method of the invention include chloroperoxidases, bromoperoxidases and compounds exhibiting chloroperoxidase or bromoperoxidase activity. Haloperoxidases form a class of enzymes, which are capable of oxidizing halides (Cl⁻, Br⁻, I⁻) in the presence of hydrogen peroxide or a hydrogen peroxide generating system to the corresponding hypohalous acids.

Haloperoxidases are classified according to their specificity for halide ions. Chloroperoxidases (E.C. 1.11.1.10) catalyze formation of hypochlorite from chloride ions, hypobromite from bromide ions and hypoiodite from iodide ions; and bromoperoxidases catalyze formation of hypobromite from bromide ions and hypoiodite from iodide ions. Hypoiodite, however, undergoes spontaneous disproportionation to iodine and thus iodine is the observed product. These hypohalite compounds may subsequently react with other compounds forming halogenated compounds.

In a preferred embodiment, the haloperoxidase of the invention is a chloroperoxidase.

Haloperoxidases have been isolated from various organisms: mammals, marine animals, plants, algae, lichen, fungi and bacteria. It is generally accepted that haloperoxidases are the enzymes responsible for the formation of halogenated compounds in nature, although other enzymes may be involved.

Haloperoxidases have been isolated from many different fungi, in particular from the fungus group dematiaceous hyphomycetes, such as Caldariomyces, e.g., C. fumago, Alternaria, Curvularia, e.g., C. verruculosa and C. inaequalis, Drechslera, Ulocladium and Botrytis.

Haloperoxidases have also been isolated from bacteria such as Pseudomonas, e.g., P. pyrrocinia and Streptomyces, e.g., S. aureofaciens.

In a preferred embodiment, the haloperoxidase is a vanadium haloperoxidase (i.e., a vanadium or vanadate containing haloperoxidase) derivable from Curvularia sp., in particular Curvularia verruculosa or Curvularia inequalis, such as C. inaequalis CBS 102.42 as described in WO 95/27046, e.g., a vanadium haloperoxidase encoded by the DNA sequence of WO 95/27046, FIG. 2 all incorporated by reference; or C. verruculosa CBS 147.63 or C. verruculosa CBS 444.70 as described in WO 97/04102. Preferably, the amino acid sequence of the haloperoxidase has at least 90% identity, preferably 95% identity to the amino acid sequence of a haloperoxidase obtainable from Curvularia verruculosa (see e.g., SEQ ID NO:2 in WO 97/04102) or Curvularia inequalis (e.g., the mature amino acid sequence encoded by the DNA sequence in FIG. 2 of WO 95/27046).

In another preferred embodiment the haloperoxidase is a vanadium containing haloperoxidase; in particular a vanadium chloroperoxidase. The vanadium chloroperoxidase may be derivable from Drechslera hartlebii as described in WO 01/79459, Dendryphiella salina as described in WO 01/79458, Phaeotrichoconis crotalarie as described in WO 01/79461, or Geniculosporium sp. as described in WO 01/79460. The vanadium haloperoxidase is more preferably derivable from Drechslera hartlebii (DSM 13444), Dendryphiella salina (DSM 13443), Phaeotrichoconis crotalarie (DSM 13441) or Geniculosporium sp. (DSM 13442).

The concentration of the haloperoxidase is typically in the range of 0.01-100 ppm enzyme protein, preferably 0.05-50 ppm enzyme protein, more preferably 1-40 ppm enzyme protein, more preferably 0.1-20 ppm enzyme protein, and most preferably 0.5-10 ppm enzyme protein.

In an embodiment, the concentration of the haloperoxidase is typically in the range of 5-50 ppm enzyme protein, preferably 5-40 ppm enzyme protein, more preferably 8-32 ppm enzyme protein.

### Determination of Haloperoxidase Activity

An assay for determining haloperoxidase activity may be carried out by mixing 100 microliters of haloperoxidase sample (about 0.2 μg/ml) and 100 microliters of 0.3 M sodium phosphate pH 7 buffer—0.5 M potassium bromide—0.008% phenol red, adding the solution to 10 microliters of 0.3% H₂O₂, and measuring the absorption at 595 nm as a function of time.

Another assay using monochlorodimedone (Sigma M4632, ε=20000 M⁻¹ cm⁻¹ at 290 nm) as a substrate may be carried out by measuring the decrease in absorption at 290 nm as a function of time. The assay is done in an aqueous solution of 0.1 M sodium phosphate or 0.1 M sodium acetate, 50 micro-M monochlorodimedone, 10 mM KBr/KCl, 1 mM H₂O₂ and about 1 micrograms/ml haloperoxidase. One haloperoxidase unit (HU) is defined as 1 micromol of monochlorodimedone chlorinated or brominated per minute at pH 5 and 30° C.

### Hydrogen Peroxide

The hydrogen peroxide required by the haloperoxidase may be provided as an aqueous solution of hydrogen peroxide or a hydrogen peroxide precursor for in situ production of hydrogen peroxide. Any solid entity which liberates upon dissolution a peroxide which is useable by haloperoxidase can serve as a source of hydrogen peroxide. Compounds which yield hydrogen peroxide upon dissolution in water or an appropriate aqueous based medium include but are not limited to metal peroxides, percarbonates, persulphates, perphosphates, peroxyacids, alkyperoxides, acylperoxides, peroxyesters, urea peroxide, perborates and peroxycarboxylic acids or salts thereof.

Another source of hydrogen peroxide is a hydrogen peroxide generating enzyme system, such as an oxidase together with a substrate for the oxidase. Examples of combinations of oxidase and substrate comprise, but are not limited to, amino acid oxidase (see e.g., U.S. Pat. No. 6,248,575) and a suitable amino acid, glucose oxidase (see e.g., WO 95/29996) and glucose, lactate oxidase and lactate, galactose oxidase (see e.g., WO 00/50606) and galactose, and aldose oxidase (see e.g., WO 99/31990) and a suitable aldose.

By studying EC 1.1.3._, EC 1.2.3._, EC 1.4.3._, and EC 1.5.3._ or similar classes (under the International Union of Biochemistry), other examples of such combinations of oxidases and substrates are easily recognized by one skilled in the art.

Hydrogen peroxide or a source of hydrogen peroxide may be added at the beginning of or during the process, e.g., typically in an amount corresponding to levels of from 0.001 mM to 25 mM, preferably to levels of from 0.005 mM to 5 mM, and particularly to levels of from 0.01 to 1 mM hydrogen peroxide. Hydrogen peroxide may also be used in an amount corresponding to levels of from 0.1 mM to 25 mM, preferably to levels of from 0.5 mM to 15 mM, more preferably to levels of from 1 mM to 10 mM, and most preferably to levels of from 2 mM to 8 mM hydrogen peroxide.

### Chloride or Bromide Ions

According to the invention, the chloride or bromide ions (Cl⁻ or Br⁻) needed for the reaction with the haloperoxidase may be provided in many different ways, such as by adding a salt of chloride or bromide. In a preferred embodiment the salt of chloride or bromide is sodium chloride (NaCl), sodium bromide (NaBr), potassium chloride (KCl), potassium bromide (KBr), ammonium chloride (NH₄Cl) or ammonium bromide (NH₄Br); or a mixture thereof.

In an embodiment, the chloride or bromide ions are limited to only chloride ions (Cl⁻). The chloride ions may be provided by adding a salt of chloride to an aqueous solution. The salt of chloride may be sodium chloride, potassium chloride or ammonium chloride; or a mixture thereof.

In another embodiment, the chloride or bromide ions are limited to only bromide ions (Br⁻). The bromide ions may be provided by adding a salt of bromide to an aqueous solution. The salt of bromide may be sodium bromide, potassium bromide or ammonium bromide; or a mixture thereof.

The concentration of chloride or bromide ions is typically in the range of from 0.01 mM to 1000 mM, preferably in the range of from 0.05 mM to 500 mM, more preferably in the range of from 0.1 mM to 100 mM, most preferably in the range of from 0.1 mM to 50 mM, and in particular in the range of from 1 mM to 25 mM. When both chloride and bromide ions are used, the concentration of chloride ions is independent of the concentration of bromide ions; and vice versa.

In a preferred embodiment, the methods, compositions and uses according to the present invention, include chloride and bromide ions; for example provided by using a mixture of chloride salt(s) and bromide salt(s).

In an embodiment, the molar concentration of chloride or bromide ions is at least two times higher, preferably at least four times higher, more preferably at least six times higher, most preferably at least eight times higher, and in particular at least ten times higher than the concentration of ammonium ions.

### Ammonium Ions

The ammonium ions (NH₄⁺) needed to kill or inactivate microbial spores according to the methods of the invention may be provided in many different ways, such as by adding a salt of ammonium. In a preferred embodiment the ammonium salt is ammonium sulphate ((NH₄)₂SO₄), ammonium carbonate ((NH₄)₂CO₃), ammonium chloride (NH₄Cl), ammonium bromide (NH₄Br), or ammonium iodide (NH₄I); or a mixture thereof.

The concentration of ammonium ions is typically in the range of from 0.01 mM to 1000 mM, preferably in the range of from 0.05 mM to 500 mM, more preferably in the range of from 0.1 mM to 100 mM, most preferably in the range of from 0.1 mM to 50 mM, and in particular in the range of from 1 mM to 25 mM.

### Microbial Spores

The microbial spores which are killed or inactivated with a haloperoxidase, hydrogen peroxide, chloride or bromide ions, and ammonium ions according to the invention comprise all kinds of spores.

In an embodiment the microbial spores are endospores, such as all Clostridium sp. spores, Brevibacillus sp. spores and Bacillus sp. spores, e.g., spores from Bacillus anthracis, Bacillus cereus, Bacillus subtilis, Bacillus putida, and Bacillus pumila.

In another embodiment the microbial spores are exospores, such as Actinomycetales spores, e.g., spores from Actinomyces sp., Streptomyces sp., Thermoactinomyces sp., Saccharomonospora sp., and Saccharopylospora sp.

In another embodiment the microbial spores are bacterial spores. Examples of bacterial spores include, but are not limited to, all Clostridium sp. spores and Bacillus sp. spores as mentioned above.

In yet another embodiment the microbial spores are fungal spores. Examples of fungal spores include, but are not limited to, conidiospores, such as spores from Aspergillus sp., and Penicillium sp.

### Surfactants

The method of the invention may include application of a surfactant (as part of a detergent formulation or as a wetting agent). Surfactants suitable for being applied may be non-ionic (including semi-polar), anionic, cationic and/or zwitterionic; preferably the surfactant is anionic (such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap) or non-ionic (such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”)), or a mixture thereof.

When included in the method of the invention, the concentration of the surfactant will usually be from about 0.01% to about 10%, preferably about 0.05% to about 5%, and more preferably about 0.1% to about 1% by weight.

### Methods and Uses

In a first aspect, the present invention provides an enzymatic method for killing or inactivating spores, comprising contacting the spores with a composition which includes a haloperoxidase, hydrogen peroxide, chloride and/or bromide ions, and ammonium ions. In a preferred embodiment the composition includes a haloperoxidase, hydrogen peroxide, chloride ions and ammonium ions. In another aspect, the present invention provides a method for disinfecting or sterilizing a device, preferably a medical device, which comprises contacting the (medical) device with the composition.

The composition may be formulated as a liquid (e.g., aqueous) or a dry product formulation. The dry product formulation may subsequently be re-hydrated to form an active liquid or semi-liquid formulation usable in the method of the invention.

When the composition is formulated as a dry formulation, the components may be mixed, arranged in discrete layers or packed separately.

In a second aspect, the invention also covers a composition which results from applying the method of the invention. In this case, the composition comprises a haloperoxidase, hydrogen peroxide, chloride or bromide ions, ammonium ions and microbial spores; or the comprises a haloperoxidase, hydrogen peroxide, chloride or bromide ions, ammonium ions and a medical device.

The method of the invention is useful for decontamination of locations which have been exposed to spores, such as biological warfare agents, e.g., spores of Bacillus anthracis capable of causing anthrax.

In the context of the present invention the term “killing or inactivating spores” is intended to mean that at least 99% of the spores are not capable of transforming (germinating) into vegetative cells. Preferably 99.9%, more preferably 99.99%, most preferably 99.999%, and in particular 99.9999% of the spores are not capable of transforming into vegetative cells.

In an embodiment, the term “disinfecting” or “disinfection” refers to high level disinfection according to “Content and Format of Premarket Notification [510(k)] Submissions for Liquid Chemical Sterilants/High Level Disinfectants”, U.S. Food and Drug Administration, January 2000.

The methods according to the invention may be carried out at a temperature between 0 and 90 degrees Celsius, preferably between 5 and 80 degrees Celsius, more preferably between 10 and 70 degrees Celsius, even more preferably between 15 and 60 degrees Celsius, most preferably between 18 and 50 degrees Celsius, and in particular between 20 and 40 degrees Celsius.

In another embodiment, the methods of the invention may be carried out at a temperature between 30 and 70 degrees Celsius, preferably between 40 and 60 degrees Celsius.

The methods of the invention may employ a treatment time of from 10 minutes to (at least) 4 hours, preferably from 15 minutes to (at least) 3 hours, more preferably from 20 minutes to (at least) 2 hours, most preferably from 20 minutes to (at least) 1 hour, and in particular from 30 minutes to (at least) 1 hour.

The method of the invention is suitable for killing or inactivating spores in a variety of environments. The method of the invention may desirably be used in any environment to reduce spore contamination, such as the health-care industry (e.g., animal hospitals, human hospitals, animal clinics, human clinics, nursing homes, day-care facilities for children or senior citizens, etc.), the food industry (e.g., restaurants, food-processing plants, food-storage plants, grocery stores, etc.), the hospitality industry (e.g., hotels, motels, resorts, cruise ships, etc.), the education industry (e.g., schools and universities), etc.

Due to the relatively low temperatures being utilized by the methods of the invention, they are very useful for disinfecting or sterilizing equipment, such as medical devices (e.g., dry surgical instruments, anesthesia equipment, hollowware etc), used in the health-care industry. The disinfected or sterilized equipment will exhibit reduced deformations and wear, and the equipment is ready for use substantially immediately after disinfection or sterilization. This is especially advantageous when disinfecting or sterilizing complex or heat sensitive medical devices such as ultrasound transducers and endoscopes comprising different materials, because the wear of these devices have been reduced significantly, which results in longer durability of these often very costly devices, which effectively reduces their operational cost. Indeed, even other non-medical types of equipment such as reusable hygienic articles may be disinfected or sterilized effectively by use of the present invention.

In a preferred embodiment, the disinfection or sterilization of medical devices and/or non-medical types of equipment takes place in a (Medical) Washer-Disinfector according to EN ISO 15883-1 (or as described in “Class II Special Controls Guidance Document: Medical Washers and Medical Washer-Disinfectors; Guidance for the Medical Device Industry and FDA Review Staff”, U.S. Food and Drug Administration, February 2002), using the methods of the invention.

The method of the invention may desirably be used in any environment to reduce spore contamination, such as general-premise surfaces (e.g., floors, walls, ceilings, exterior of furniture, etc.), specific-equipment surfaces (e.g., hard surfaces, manufacturing equipment, processing equipment, etc.), textiles (e.g., cottons, wools, silks, synthetic fabrics such as polyesters, polyolefins, and acrylics, fiber blends such as cottonpolyester, etc.), wood and cellulose-based systems (e.g., paper), soil, animal carcasses (e.g., hide, meat, hair, feathers, etc.), foodstuffs (e.g., fruits, vegetables, nuts, meats, etc.), and water.

In one embodiment, the method of the invention is directed to sporicidal treatment of textiles. Spores of the Bacillus cereus group have been identified as the predominant postlaundering contaminant of textiles. Thus, the treatment of textiles with a composition of the invention is particularly useful for sporicidal activity against the contaminants of textiles.

Examples of textiles that can be treated with the composition of the invention include, but are not limited to, personal items (e.g., shirts, pants, stockings, undergarments, etc.), institutional items (e.g., towels, lab coats, gowns, aprons, etc.), hospitality items (e.g., towels, napkins, tablecloths, etc.).

A sporicidal treatment of textiles with a composition of the invention may include contacting a textile with a composition of the invention. This contacting can occur prior to laundering the textile. Alternatively, this contacting can occur during laundering of the textile to provide sporicidal activity and optionally provide cleansing activity to remove or reduce soils, stains, etc. from the textile.

The spores which are contacted by the composition of the invention may be located on any surface including, but not limited to, a surface of a process equipment used in e.g., a dairy, a chemical or pharmaceutical process plant, a medical device such as an endoscope or other medical utensils, a piece of laboratory equipment, a washing machine, a water sanitation system, an oil processing plant, a paper pulp processing plant, a water treatment plant, or a cooling tower. The composition of the invention should be used in an amount, which is effective for killing or inactivating the spores on the surface in question.

The spores may be contacted by the composition used in the method of the invention by submerging the spores in an aqueous formulation of the composition (e.g., a laundering process), by spraying the composition onto the spores, by applying the composition to the spores by means of a cloth, or by any other method recognized by the skilled person. Any method of applying the composition of the invention to the spores, which results in killing or inactivating the spores, is an acceptable method of application.

The method of the invention is also useful for decontamination of locations which have been exposed to spores (e.g., pathogenic spores), such as biological warfare agents, e.g., spores of Bacillus anthracis capable of causing anthrax. Such locations include, but are not limited to, clothings (such as army clothings), inner and outer parts of vehicles, inner and outer parts of buildings, any kind of army facility, and any kind of environment mentioned above.

The present invention is further described by the following examples which should not be construed as limiting the scope of the invention.

### EXAMPLES

Chemicals used as buffers and substrates were commercial products of at least reagent grade. In the following Examples, the symbol “-” means “not determined”.

### Example 1

### Spore Production

Streak a Tryptose Blod Agar Base (TBAB) plate from a fresh culture of Bacillus globigii or B. thuringiensis (Bacillus thuringiensis type strain ATCC10792). Incubate the culture overnight at 30 degrees Celsius.

Suspend a loopfull of pure Bacillus from the TBAB plate and suspend the cells in 2 mL of sterile water. Inoculate 2×SG plates with 100 microliters of the cell suspension on each. The composition of 2×SG is as follows: 16 g/L Difco Bacto Nutrient Broth, 0.5 g/L MgSO₄×7H₂O, 2.0 g/L KCl, 1.0 mL/100 mL of 10% glucose, 0.1 mL/100 mL of 1 M Ca(NO₃)₂, 0.1 mL/100 mL of 0.1 M MnSO₄, 10 microliters/100 mL of 0.01 M FeSO₄, and 1% Difco Bacto Agar. Incubate plates for 4872 hours at 30 degrees Celsius. Check for sporulation with phase-contrast microscopy. Spores are phase-bright.

When sporulation efficiency is close to 100%, harvest the cell lawn with water and suspend the cells by intensive vortexing. Collect cells by centrifugation for 5-10 minutes at 6000 G at 4 degrees Celsius. Wash cells 3 times with ice cold water. The pellet contains vegetative cells and spores.

Apply a step-density gradient for separation of the spores from the vegetative cells. Prepare for each washed pellet a centrifuge tube containing 30 mL 43% Urographin®. Prepare 3 mL of cell spore mixture in Urographin so that the final Urographin concentration is 20%. Gently load the 20% Urographin cell/spore mixture onto the top layer of the 43% Urographin.

Centrifuge at 10000 G at room temperature for 30 minutes. Gently remove supernatant.

Suspend the pure spore pellet in 1 mL ice-cold water and transfer to a microfuge tube. Centrifuge at maximum speed for 1-2 min at 4 degrees Celsius, wash pellet in ice-cold water 2 more times.

Check purity and number of spores/ml by phase contrast microscopy and a haemocytometer. Store spores suspended in water at −20 degrees Celsius.

### Example 2

### Killing of Bacillus Spores in Liquid Preparations

The following reagents were prepared:

DMG buffer (DiMethylGlutamic acid, Sigma D4379), 100 mM, pH adjusted to 6.0 with NaOH;

1×10⁸ Bacillus atrophaeus spores per mL (Bacillus atrophaeus spores: SUS-1-8 Log. Raven Labs, www.Ravenlabs.com), suspended in MilliQ water;

1×10⁸ Bacillus thuringiensis spores per mL (made according to Example 1), suspended in MilliQ water;

50 mg/L Haloperoxidase from Curvularia verrucolosa (see WO 97/04102) in MilliQ water;

800 mM Sodium chloride (NaCl) in MilliQ water;

100 mM Ammonium sulphate ((NH₄)₂SO₄) in MilliQ water;

10 mM Hydrogen peroxide (H₂O₂) in MilliQ water; and

LB plates were made from 37 g LB Agar (Merck 0283) dissolved in 1000 mL water.

In a vial the following was mixed:

10 microliters spore suspension,
250 microliters DMG buffer,
40 microliters NaCl solution,
40 microliters (NH₄)₂SO₄ solution, and
20 microliters Haloperoxidase solution.

The reaction was started with addition of 40 microliters Hydrogen peroxide.

A vial with 10 microliters spore suspension and 490 microliters MilliQ water acted as a control.

The vials were incubated at room temperature (approximately 23° C.) for 110 minutes. After that a dilution series was made in MilliQ water, and 100 microliters from the dilutions 10⁰ to 10⁻⁵ were plated (in duplicate) onto LB agar plates. The plates were incubated for 48 hours at 33° C., and the average number of colony forming units (CFU) on each pair of duplicate plates was registered (shown in Table 1).

TABLE 1

| | |
|---|---|
| Bacillus atrophaeus | Bacillus thuringiensis |
| spores | spores |

| Dilution | Control | Treated | Control | treated |
|---|---|---|---|---|
| 10⁰ | >>200 | 0 | >>200 | 0 |
| 10⁻¹ | >>200 | 0 | >>200 | 0 |
| 10⁻² | >>200 | 0 | >>200 | 0 |
| 10⁻³ | >200 | 0 | 99 | 0 |
| 10⁻⁴ | 70 | 0 | 11 | 0 |
| 10⁻⁵ | 4 | 0 | 1 | 0 |

The results shown in Table 1 indicate that the haloperoxidase solution of the invention has a clear and significant sporicidal effect. The number of spores able to germinate after the treatment was reduced at least 5 log units.

### Example 3

### Killing of Bacillus Spores on a Stainless Steel Surface

The following reagents were prepared:

DMG buffer (DiMethylGlutamic acid, Sigma D4379), 50 mM, pH adjusted to 7.0 with NaOH;

200 mg/L Haloperoxidase from Curvularia verrucolosa (see WO 97/04102) in 50 mM DMG buffer;

400 mM Sodium chloride (NaCl) in MilliQ water;

100 mM Ammonium sulphate ((NH₄)₂SO₄) in MilliQ water;

10 mM Hydrogen peroxide (H₂O₂) in MilliQ water;

5% Sodium thiosulphate (Na₂S₂O₃)

tubes containing 5 mL of 1% Tween 80 in water and approximately 1 mL glass beads (3 mm); and

LB plates were made from 37 g LB Agar (Merck 0283) dissolved in 1000 mL water.

Stainless steel discs each containing 10⁶ Bacillus atrophaeus spores (Raven Labs cat. #1-6100ST) were used for the experiment (one disc was used for one treatment).

In a vial the following components were mixed:

373.75 microliters DMG buffer,
31.25 microliters NaCl solution,
25 microliters (NH₄)₂SO₄ solution,
20 microliters Haloperoxidase solution, and
One Bacillus atrophaeus spore disc (10⁶ spores).

The reaction was started with addition of 50 microliters Hydrogen peroxide. A vial with a spore disc and 500 microliters DMG buffer acted as a control.

The vials were incubated at 40° C. for 45 minutes. To stop the reaction 500 microliters Sodium thiosulphate was added, and incubated for 15 minutes at room temperature (approximately 23° C.). Each disc was then transferred to a tube containing Tween 80 and glass beads, and the tubes were shaken for 15 minutes at 300 rpm.

After that a dilution series was made in MilliQ water, and 500 microliters from the dilutions 10⁻¹ to 10⁻³ were plated onto LB agar plates (14 cm plates). The remaining liquid from the 100 solution (approximately 4.9 mL) was plates out on big LB plates (square, 20×20 cm plates).

The plates were incubated for 48 hours at 37° C., and the average number of colony forming units (CFU) on each plate was registered (shown in Table 2).

TABLE 2

| | | Bacillus atrophaeus spores | |
|---|---|---|---|
| | | (CFU on plates) | |
| Dilution | | Control | Treated |
| 10⁰ | (4.9 mL) | >>1000 | 0 |
| 10⁻¹ | (500 microliters) | >>200 | 0 |
| 10⁻² | (500 microliters) | >>200 | 0 |
| 10⁻³ | (500 microliters) | 100 | 0 |

| | | |
|---|---|---|
| Calculated number of spores left | 1,000,000 spores/disc | 0 spores/disc |
| on disc after treatment | | |

The results shown in Table 2 indicate that the haloperoxidase solution of the invention has a clear and significant sporicidal effect. The number of spores able to germinate after the treatment was reduced 6 log units.

### Example 4

### Killing of Bacillus Spores on a Surface Including Use of a Commercial Cleaning Agent

The following reagents were prepared:

Commercial cleaning agent (pH 7.0) diluted to the specified working solution with water;

DMG buffer (DiMethylGlutamic acid, Sigma D4379), 50 mM, pH adjusted to 7.0 with NaOH;

200 mg/L Haloperoxidase from Curvularia verrucolosa (see WO 97/04102) in 50 mM DMG buffer;

400 mM Sodium chloride (NaCl) in MilliQ water;

100 mM Ammonium sulphate ((NH₄)₂SO₄) in MilliQ water;

10 mM Hydrogen peroxide (H₂O₂) in MilliQ water;

5% Sodium thiosulphate (Na₂S₂O₃)

tubes containing 5 mL of 1% Tween 80 in water and approximately 1 mL glass beads (3 mm); and

LB plates were made from 37 g LB Agar (Merck 0283) dissolved in 1000 mL water.

Stainless steel discs each containing 10⁶ Bacillus atrophaeus spores (Raven Labs cat. #1-6100ST) were used for the experiment (one disc was used for one treatment).

Three vials were prepared as indicated in Table 3. The reaction in Vial 1 and Vial 2 was started with addition of 50 microliters Hydrogen peroxide.

TABLE 3

| Vial 1 | Vial 2 | Vial 3 (control) |
|---|---|---|
| 350 microliters DMG | 350 microliters Cleaning | 500 microliters |
| buffer, | agent, | Cleaning agent, |
| 62.5 microliters NaCl | 62.5 microliters NaCl | a Bacillus atrophaeus |
| solution, | solution, | spore disc |
| 25 microliters | 25 microliters | (10⁶ spores). |
| (NH₄)₂SO₄ solution | (NH₄)₂SO₄ solution | |
| 12.5 microliters | 12.5 microliters | |
| Haloperoxidase | Haloperoxidase | |
| a Bacillus atrophaeus | a Bacillus atrophaeus | |
| spore disc | spore disc (10⁶ spores). | |
| (10⁶ spores). | 50 microliters Hydrogen | |
| 50 microliters | peroxide | |
| Hydrogen peroxide | | |

The vials from Table 3 were incubated at 40° C. for 30 minutes. To stop the reaction 500 microliters Sodium thiosulphate was added, and incubated for 15 minutes at room temperature (approximately 23° C.). Each disc was then transferred to a tube containing Tween 80 and glass beads, and the tubes were shaken for 15 minutes at 300 rpm.

After that a dilution series was made in MilliQ water and 500 microliters from the dilutions 10⁰ to 10⁻³ were plated onto LB agar plates (14 cm plates). The plates were incubated for 48 hours at 37° C., and the average number of colony forming units (CFU) on each plate was registered (shown in Table 4).

TABLE 4

| Dilution | Vial 1 | Vial 2 | Vial 3 (control) |
|---|---|---|---|
| 10⁰ (500 microliters) | 10 | 3 | >>200 |
| 10⁻¹ (500 microliters) | 1 | 0 | >>200 |
| 10⁻² (500 microliters) | 0 | 0 | >>200 |
| 10⁻³ (500 microliters) | 0 | 0 | 90 |
| Calculated number | 100 spores/disc | 30 spores/disc | 900,000 |
| of spores left on disc | | | spores/disc |
| after treatment | | | |

The results shown in Table 4 indicate that the haloperoxidase solution of the invention has a clear and significant sporicidal effect, which is enhanced when the solution is used with a commercial cleaning agent.

The number of spores able to germinate after treatment with the haloperoxidase solution alone was reduced 4 log units. If the solution was used with a commercial cleaning agent, the number of spores able to germinate was reduced 4-5 log units.

### Example 5

### Killing Spores with Combinations of Chloride, Bromide and Ammonium Ions

The following reagents were prepared:

DMG buffer (DiMethylGlutamic acid, Sigma D4379), 100 mM, pH adjusted to 7.0 with NaOH;

1×10⁹ Bacillus atrophaeus spores per mL (Bacillus atrophaeus spores: SUS-1-8 Log. Raven Labs, www.Ravenlabs.com);

40 mg/L Haloperoxidase from Curvularia verrucolosa (see WO 97/04102) in MilliQ water;

500 mM Sodium bromide (NaBr) in MilliQ water;

1000 mM Sodium chloride (NaCl) in MilliQ water;

500 mM Ammonium chloride (NH₄Cl) in MilliQ water

10 mM Hydrogen peroxide (H₂O₂) in MilliQ water;

5% (w/v) Sodium thiosulphate (Na₂S₂O) in MilliQ water; and

LB plates were made from 37 g LB Agar (Merck 0283) dissolved in 1000 mL water.

In vials, reagents were mixed according to Table 5.

TABLE 5

| | 1 mM bromide + | 5 mM bromide + | 24 mM |
|---|---|---|---|
| Reagent | 24 mM chloride | 24 mM chloride | chloride |
| NaCl (microliters) | 9 | 9 | 9 |
| NaBr (microliters) | 1 | 5 | 0 |
| NH₄Cl (microliters) | 6 | 6 | 6 |
| DMG buffer pH 7.0 | 250 | 250 | 250 |
| (microliters) | | | |
| Haloperoxidase | 100 | 100 | 100 |
| (microliters) | | | |
| H₂O₂ (microliters) | 100 | 100 | 100 |
| Spores (microliters) | 5 | 5 | 5 |
| MilliQ water | 24 | 20 | 25 |
| (microliters) | | | |

The reaction was started by adding hydrogen peroxide. A vial with 10 microliters spore suspension and 490 microliters MilliQ water acted as a control.

The vials were incubated at 40° C. for 30 minutes. The reaction was then quenched by addition of 500 microliters sodium thiosulphate, which was allowed to react for 15 minutes.

After that, a dilution series was made in MilliQ water, and 100 microliters from the dilutions 10⁰ to 10⁻⁵ were plated (in duplicate) on LB agar plates. The plates were incubated for 48 hours at 33° C., and the average number of colony forming units per plate (CFU/plate) on each set of plates were registered (shown in Table 6).

TABLE 6

| | | 1 mM | 5 mM | | |
|---|---|---|---|---|---|
| | | bromide + | bromide + | | |
| | | 24 mM | 24 mM | 24 mM | |
| | Dilution | chloride | chloride | chloride | Control |
| CFU/plate | 10⁰ | 31 | 28 | — | — |
| | 10⁻¹ | 4 | 1 | 40 | — |
| | 10⁻² | 0 | 0 | 3 | — |
| | 10⁻³ | 0 | 0 | 0 | — |
| | 10⁻⁴ | — | — | — | 180 |
| | 10⁻⁵ | — | — | — | 20 |
| CFU/mL | — | 3 × 10² | 3 × 10² | 4 × 10³ | 2 × 10⁷ |
| Kill (Log Units) | — | 4.8 | 4.8 | 3.7 | — |

The results shown in Table 6 indicate that addition of bromide to the Haloperoxidase/chloride/ammonium solution boosts the sporicidal effect with at least 1 log unit.

The number of spores able to germinate after the treatment was reduced at least 1 log unit more than when only treated with the chloride/ammonium/haloperoxidase solution.

### Example 6

### Killing of Bacillus Spores with Varying Ratios of Bromide/Chloride Ions

The following reagents were prepared:

DMG buffer (DiMethylGlutamic acid, Sigma D4379), 100 mM, pH adjusted to 7.0 with NaOH;

1×10⁹ Bacillus atrophaeus spores per mL (Bacillus atrophaeus spores: SUS-1-8 Log. Raven Labs, www.Ravenlabs.com);

250 mg/L Haloperoxidase from Curvularia verrucolosa (see WO 97/04102) in MilliQ water;

50 mM Sodium bromide (NaBr) in MilliQ water;

200 mM Sodium chloride (NaCl) in MilliQ water;

200 mM Ammonium chloride (NH₄Cl) in MilliQ water

10 mM Hydrogen peroxide (H₂O₂) in MilliQ water;

5% (w/v) Sodium thiosulphate (Na₂S₂O₃) in MilliQ water; and

LB plates were made from 37 g LB Agar (Merck 0283) dissolved in 1000 mL water.

In vials, reagents were mixed according to Table 7.

TABLE 7

| | Bromide/chloride | | | | | |
|---|---|---|---|---|---|---|
| | 25 mM/ | 5 mM/ | 2.5 mM/ | 1 mM/ | 0.5 mM/ | 0.25 mM/ |
| Reagents | 25 mM | 25 mM | 25 mM | 25 mM | 25 mM | 25 mM |
| NaCl (microliters) | 47.5 | 47.5 | 47.5 | 47.5 | 47.5 | 47.5 |
| NaBr (microliters) | 250 | 50 | 25 | 10 | 5 | 2.5 |
| NH₄Cl (microliters) | 15 | 15 | 15 | 15 | 15 | 15 |
| Buffer (microliters) | 50 | 50 | 50 | 50 | 50 | 50 |
| Haloperoxidase | 16 | 16 | 16 | 16 | 16 | 16 |
| (microliters) | | | | | | |
| H₂O₂ (microliters) | 100 | 100 | 100 | 100 | 100 | 100 |
| Spores (microliters) | 10 | 10 | 10 | 10 | 10 | 10 |
| MilliQ water | 11.5 | 211.5 | 236.5 | 251.5 | 256.5 | 259 |
| (microliters) | | | | | | |

The reaction was started by adding hydrogen peroxide. A vial with 10 microliters spore suspension and 490 microliters MilliQ water acted as a control.

The vials were incubated at 22° C. for 30 minutes. The reaction was then quenched by addition of 500 microliters sodium thiosulphate, which was allowed to react for 15 minutes.

After that a dilution series was made in MilliQ water, and 100 microliters from the dilutions 10⁰ to 10⁻⁵ were plated (in duplicate) onto LB agar plates. The plates were incubated for 48 hours at 33° C., and the average number of colony forming units per plate (CFU/plate) on each set of plates was registered (shown in Table 8).

TABLE 8

| | | Bromide/chloride | | | | | |
|---|---|---|---|---|---|---|---|
| | | 25 mM/ | 5 mM/ | 2.5 mM/ | 1 mM/ | 0.5 mM/ | 0.25 mM/ |
| Dilution | Control | 25 mM | 25 mM | 25 mM | 25 mM | 25 mM | 25 mM |
| 10⁰ | — | — | — | — | — | — | — |
| 10⁻¹ | — | 35 | 61 | 62 | 11 | 41 | 6 |
| 10⁻² | — | — | — | — | — | — | — |
| 10⁻³ | — | — | 3 | 1 | 0 | 4 | 1 |
| 10⁻⁴ | — | — | — | — | — | — | — |
| 10⁻⁵ | 20 | — | — | — | — | — | — |
| CFU/mL | 2 × 10⁷ | 3.5 × 10³ | 5 × 10³ | 6 × 10³ | 1 × 10³ | 4 × 10³ | 6 × 10² |
| Kill (Log Units) | — | 3.7 | 3.6 | 3.5 | 4.3 | 3.7 | 4.4 |

The results indicate that the biocidal effect is more or less independent of the bromide concentration, but with an inclination of a slightly better kill with low bromide/chloride ratios.

### Example 7

### Killing of Bacillus Spores in Liquid Preparations at Various pH Values

The following reagents were prepared:

Phosphate buffer 100 mM, with the following pH values: pH 6.0, pH 6.5, pH 7.0, pH 7.4 and pH 8.0;

Britton Robinson buffer 100 mM, pH 8.5;

1×10⁹ Bacillus atrophaeus spores per mL (Bacillus atrophaeus spores: SUS-1-8 Log. Raven Labs, www.Ravenlabs.com);

250 mg/L Haloperoxidase from Curvularia verrucolosa (see WO 97/04102) in MilliQ water;

200 mM Sodium chloride (NaCl) in MilliQ water;

50 mM Sodium bromide (NaBr) in MilliQ water;

200 mM Ammonium chloride (NH₄Cl) in MilliQ water;

10 mM Hydrogen peroxide (H₂O₂) in MilliQ water; and

LB plates were made from 37 g LB Agar (Merck 0283) dissolved in 1000 mL water.

In vials, reagents were mixed according to Table 9.

TABLE 9

| | pH | | pH | | | |
|---|---|---|---|---|---|---|
| Reagents | 6.0 | pH 6.5 | 7.0 | pH 7.4 | pH 8.0 | pH 8.5 |
| NaCl (microliters) | 47.5 | 47.5 | 47.5 | 47.5 | 47.5 | 47.5 |
| NaBr (microliters) | 5 | 5 | 5 | 5 | 5 | 5 |
| NH₄Cl (microliters) | 15 | 15 | 15 | 15 | 15 | 15 |
| Buffer (microliters) | 50 | 50 | 50 | 50 | 50 | 50 |
| Haloperoxidase | 16 | 16 | 16 | 16 | 16 | 16 |
| (microliters) | | | | | | |
| H₂O₂ (microliters) | 100 | 100 | 100 | 100 | 100 | 100 |
| Spore solution | 10 | 10 | 10 | 10 | 10 | 10 |
| (microliters) | | | | | | |
| MilliQ water | 256.5 | 256.5 | 256.5 | 256.5 | 256.5 | 256.5 |
| (microliters) | | | | | | |

The reaction was started by adding hydrogen peroxide. A vial with 10 microliters spore suspension and 490 microliters microliters MilliQ water acted as a control.

The vials were incubated at either room temperature (approximately 22° C.), at 40° C. or at 50° C., for 30 minutes.

Then the reaction was quenched by addition of 500 microliters sodium thiosulphate, which was allowed to react for 10 minutes.

After that, a dilution series was made in MilliQ water, and 100 microliters from the dilutions 10⁰ to 10⁻⁵ were plated (in duplicate) on LB agar plates. The plates were incubated for 48 hours at 33° C., and the average number of colony forming units (CFU) on each pair of duplicate plates was registered (shown in Tables 10-12 below).

TABLE 10
Incubation temperature = 22° C.. Average CFU at each dilution
of spores treated with the haloperoxidase/chloride/ammonium solution.

| | | pH | | | | | |
|---|---|---|---|---|---|---|---|
| Dilution | pH 6.0 | 6.5 | pH 7.0 | pH 7.4 | pH 8.0 | pH 8.5 | Control |
| 10⁰ | — | 61 | 69 | 18 | — | — | — |
| 10⁻¹ | — | 5 | 5 | 2 | ~10³ | ~10⁵ | — |
| 10⁻² | — | 0 | — | — | — | — | — |
| 10⁻³ | — | 0 | — | — | — | — | — |
| 10⁻⁴ | — | — | — | — | — | — | 186 |
| 10⁻⁵ | — | — | — | — | — | — | 17 |

TABLE 11
Incubation temperature = 40° C.. Average CFU at each dilution
of spores treated with the haloperoxidase/chloride/ammonium solution.

| | | pH | | | | | |
|---|---|---|---|---|---|---|---|
| Dilution | pH 6.0 | 6.5 | pH 7.0 | pH 7.4 | pH 8.0 | pH 8.5 | Control |
| 10⁰ | — | — | — | — | — | — | — |
| 10⁻¹ | — | 36 | 34 | 31 | — | — | — |
| 10⁻² | — | 0 | — | — | — | — | — |
| 10⁻³ | 5 | 0 | — | — | 28 | — | — |
| 10⁻⁴ | 9 | — | — | — | 7 | 14 | 238 |
| 10⁻⁵ | — | — | — | — | — | 5 | 32 |

TABLE 12
Incubation temperature = 50° C.. Average CFU at each dilution
of spores treated with the haloperoxidase/chloride/ammonium solution.

| | | | | pH | | | |
|---|---|---|---|---|---|---|---|
| Dilution | pH 6.0 | pH 6.5 | pH 7.0 | 7.4 | pH 8.0 | pH8.5 | Control |
| 10⁰ | — | — | — | — | — | — | — |
| 10⁻¹ | — | 53 | 48 | 600 | — | — | — |
| 10⁻² | 6 | — | — | — | — | — | — |
| 10⁻³ | — | — | — | — | 14 | — | — |
| 10⁻⁴ | — | — | — | — | — | 9 | — |
| 10⁻⁵ | — | — | — | — | — | — | 36 |

The results are summarized in Table 13 below.

TABLE 13

| Temp. | | | | | | | | |
|---|---|---|---|---|---|---|---|---|
| (° C.) | | pH 6.0 | pH 6.5 | pH 7.0 | pH 7.4 | pH 8.0 | pH 8.5 | Control |
| 22 | CFU/mL | — | 6 × 10² | 7 × 10² | 2 × 10² | 1 × 10⁵ | 1 × 10⁷ | 2 × 10⁷ |
| | Kill (Log | — | 4.5 | 4.5 | 5 | 2.3 | 0.3 | — |
| | Units) | | | | | | | |
| 40 | CFU/mL | 5 × 10⁴ | 4 × 10³ | 3 × 10³ | 3 × 10³ | 3 × 10⁵ | 5 × 10⁶ | 2 × 10⁷ |
| | Kill (Log | 2.6 | 3.7 | 3.8 | 3.8 | 1.8 | 0.6 | — |
| | Units) | | | | | | | |
| 50 | CFU/mL | 6 × 10³ | 5 × 10³ | 5 × 10³ | 6 × 10⁴ | 1.5 × 10⁵ | 9 × 10⁵ | 3 × 10⁷ |
| | Kill (Log | 3.7 | 3.8 | 3.8 | 2.7 | 2.3 | 1.5 | — |
| | Units) | | | | | | | |

The results shown in Table 13 indicate that the haloperoxidase/chloride/bromide/ammonium solution has a clear and significant sporicidal effect. The effect is at its maximum in the pH range 6.5-7.4 at all 3 tested temperatures.

### Example 8

### Killing of Spores at Varying H₂O₂ Concentrations

The following reagents were prepared:

DMG buffer (DiMethylGlutamic acid, Sigma D4379), 100 mM, pH adjusted to 7.0 with NaOH;

1×10⁹ Bacillus atrophaeus spores per mL (Bacillus atrophaeus spores: SUS-1-8 Log. Raven Labs, www.Ravenlabs.com);

250 mg/L Haloperoxidase from Curvularia verrucolosa (see WO 97/04102) in MilliQ water;

50 mM Sodium bromide (NaBr) in MilliQ water;

200 mM Sodium chloride (NaCl) in MilliQ water;

200 mM Ammonium chloride (NH₄Cl) in MilliQ water

25 mM Hydrogen peroxide (H₂O₂) in MilliQ water;

1% (w/v) Sodium thiosulphate (Na₂S₂O₃) in MilliQ water; and

LB plates were made from 37 g LB Agar (Merck 0283) dissolved in 1000 mL water.

In vials, reagents were mixed according to Table 14.

TABLE 14

| | 0.1 | 0.5 | | | | |
|---|---|---|---|---|---|---|
| | mM | mM | 1 mM | 2 mM | 5 mM | 10 mM |
| Reagents | H₂O₂ | H₂O₂ | H₂O₂ | H₂O₂ | H₂O₂ | H₂O₂ |
| NaCl (microliters) | 47.5 | 47.5 | 47.5 | 47.5 | 47.5 | 47.5 |
| NaBr (microliters) | 5 | 5 | 5 | 5 | 5 | 5 |
| NH₄Cl (microliters) | 15 | 15 | 15 | 15 | 15 | 15 |
| Buffer (microliters) | 50 | 50 | 50 | 50 | 50 | 50 |
| Haloperoxidase | 16 | 16 | 16 | 16 | 16 | 16 |
| (microliters) | | | | | | |
| H₂O₂ (microliters) | 2 | 10 | 20 | 40 | 100 | 150 |
| Spore solution | 10 | 10 | 10 | 10 | 10 | 10 |
| (microliters) | | | | | | |
| MilliQ water | 354.5 | 346.5 | 336.5 | 316.5 | 256.5 | 206.5 |
| (microliters) | | | | | | |

The reaction was started by adding hydrogen peroxide. A vial with 10 microliters spore suspension and 490 microliters MilliQ water acted as a control.

The vials were incubated at room temperature (approximately 23° C.) for 30 minutes. The reaction was quenched by addition of 500 microliters sodium thiosulphate, which was allowed to react for 10 minutes at room temperature.

After that, a dilution series was made in MilliQ water, and 100 microliters from the dilutions 10⁰ to 10⁻⁵ were plated (in duplicate) on LB agar plates. The plates were incubated for 48 hours at 33° C., and the average number of colony forming units/plate (CFU/plate) on each pair of duplicate plates was registered (shown in Table 15).

TABLE 15

| | | 0.1 mM | 0.5 mM | 1 mM | 2 mM | 5 mM | 10 mM |
|---|---|---|---|---|---|---|---|
| Dilution | Control | H₂O₂ | H₂O₂ | H₂O₂ | H₂O₂ | H₂O₂ | H₂O₂ |
| 10⁻¹ | — | — | 150 | 2 | 0 | 1 | 3 |
| 10⁻² | — | — | — | 1 | 0 | 1 | 1 |
| 10⁻³ | — | 800 | — | 0 | 0 | 0 | 0 |
| 10⁻⁴ | 138 | — | — | 0 | 0 | 0 | 0 |
| 10⁻⁵ | 23 | — | — | 0 | 0 | 0 | 0 |
| CFU/mL | 2 × 10⁷ | 8 × 10⁶ | 1.5 × 10⁶ | 5 × 10² | 5 | 1 × 10² | 3 × 10² |
| Kill (Log Units) | — | 0.4 | 1.1 | 4.6 | 6.6 | 5.3 | 4.8 |

The results in Table 15 shows that the highest kill is achieved with 2-5 mM H₂O₂, indicating that this is the optimal hydrogen peroxide concentration under these experimental conditions. All concentrations in the range 1 mM-10 mM gives acceptable decontamination performance.

### Example 9

### Killing of Spores at Varying Ratios of Chloride/Bromide/Ammonium; Constant Haloperoxidase Concentration

The following reagents were prepared:

DMG buffer (DiMethylGlutamic acid, Sigma D4379), 100 mM, pH adjusted to 7.0 with NaOH;

1×10⁹ Bacillus atrophaeus spores per mL (Bacillus atrophaeus spores: SUS-1-8 Log. Raven Labs, www.Ravenlabs.com);

250 mg/L Haloperoxidase from Curvularia verrucolosa (see WO 97/04102) in MilliQ water;

50 mM Sodium bromide (NaBr) in MilliQ water;

200 mM Sodium chloride (NaCl) in MilliQ water;

500 mM Sodium chloride (NaCl) in MilliQ water;

200 mM Ammonium chloride (NH₄Cl) in MilliQ water

20 mM Ammonium sulphate ((NH₄)₂SO₄) in MilliQ water

100 mM Ammonium sulphate ((NH₄)₂SO₄) in MilliQ water

25 mM Hydrogen peroxide (H₂O₂) in MilliQ water;

1% (w/v) Sodium thiosulphate (Na₂S₂O₃) in MilliQ water; and

LB plates were made from 37 g LB Agar (Merck 0283) dissolved in 1000 mL water.

Following the methods and principles of the previous Examples, 500 microliters reaction mixture was made using the above-mentioned solutions. The spore treatments were carried out in vials containing:

0 mM 10.5 mM/1 mM 5 mM bromide (Br⁻);

0 mM/25 mM/50 mM/66.7 mM/100 mM/100 mM chloride (Cl⁻); and

0 mM/0.1 mM/1 mM 15 mM/0 mM/16.7 mM/25 mM/50 mM/100 mM ammonium (NH₄⁺)

in various combinations; and

8 ppm Haloperoxidase;

2 mM H₂O₂;

2×10⁷ spores;

10 mM DMG buffer; and

MilliQ water ad 500 microliters.

The reaction was started by adding hydrogen peroxide. A vial with 10 microliters spore suspension and 490 microliters MilliQ water acted as a control.

The vials were incubated at room temperature (approximately 23° C.) for 30 minutes. The reaction was quenched by addition of 500 microliters sodium thiosulphate, which was allowed to act for 10 minutes at room temperature.

After that, a dilution series was made in MilliQ water, and 100 microliters from the dilutions 10⁰ to 10⁵ were plated (in duplicate) on LB agar plates. The plates were incubated for 48 hours at 33° C., and the average number of colony forming units/plate (CFU/plate) on each set of plates was registered.

Using the CFU/mL values, the spore kill in log units was calculated, and the results are shown in Table 16.

TABLE 16
Spore kill in Log Units

| | | | 0 mM | 0.1 mM | 1 mM | 5 mM |
|---|---|---|---|---|---|---|
| | | | bromide | bromide | bromide | bromide |
| 0 mM | 0 | mM ammonium | — | 1.2 | 1.3 | 0.1 |
| chloride | 0.1 | mM ammonium | — | 1.7 | 0.5 | — |
| | 1 | mM ammonium | — | 2.5 | 3.4 | — |
| | 5 | mM ammonium | — | 1.4 | 5.8 | 4.2 |
| | 16.6 | mM ammonium | — | 0.6 | 5.2 | 3.3 |
| | 25 | mM ammonium | — | 0.3 | 5 | 4.2 |
| 25 mM | 0 | mM ammonium | 0.2 | 0.7 | 0.6 | 0.1 |
| chloride | 0.1 | mM ammonium | 0.2 | — | — | — |
| | 1 | mM ammonium | 0.5 | 4.8 | 3.5 | 3.1 |
| | 5 | mM ammonium | 0.2 | 3.7 | 3.7 | 3.2 |
| | 10 | mM ammonium | 0.2 | 1.8 | 4.2 | 3.8 |
| | 16.6 | mM ammonium | 0.2 | 0.9 | 4.6 | 3.6 |
| | 25 | mM ammonium | 0.2 | 1 | 5.5 | 4.5 |
| 50 mM | 0 | mM ammonium | 0.2 | 0.1 | 0.2 | 0.1 |
| chloride | 0.1 | mM ammonium | 0.3 | 0.4 | 0.5 | 0.2 |
| | 1 | mM ammonium | 0.6 | 2.4 | 2.5 | 1.2 |
| | 5 | mM ammonium | 0.4 | 2.5 | 4.2 | 4 |
| | 16.6 | mM ammonium | 0.3 | 0.7 | 4.5 | 3.7 |
| | 50 | mM ammonium | 0.3 | 0.3 | 3.5 | 4.2 |
| 66.7 | 0 | mM ammonium | 0.2 | — | — | — |
| mM | 0.1 | mM ammonium | — | 0.5 | 0.5 | 0.5 |
| chloride | 1 | mM ammonium | — | 4.3 | 2.9 | 1.4 |
| | 5 | mM ammonium | 0.3 | 1.8 | 5.2 | 3.2 |
| | 100 | mM ammonium | 0.3 | 0.4 | 4.2 | 4.9 |
| 100 | 0 | mM ammonium | 0.2 | 0.1 | 1.2 | 0.1 |
| mM | 0.1 | mM ammonium | — | 0.2 | 0.3 | 0.3 |
| chloride | 1 | mM ammonium | — | 2.9 | 2.7 | 1.1 |
| | 10 | mM ammonium | 0.4 | 2.1 | 4.5 | 4.2 |
| | 100 | mM ammonium | 0.2 | 0.4 | 4.2 | 4.9 |
| 150 | 0 | mM ammonium | 0.2 | 0.4 | 0.4 | 0.4 |
| mM | 0.1 | mM ammonium | — | 0.3 | 0.4 | 0.4 |
| chloride | 1 | mM ammonium | — | 2.9 | 1.5 | 1 |
| | 5 | mM ammonium | — | 1.9 | 2 | 1.7 |
| | 10 | mM ammonium | 0.6 | — | — | — |
| | 50 | mM ammonium | 0.2 | 1 | 3.9 | 3 |

The ratio of chloride/bromide/ammonium influences performance; generally a molar ratio of bromide/ammonium of 1/10 gives the highest kill.

The lower the chloride concentration is, the lower concentrations of bromide and ammonium are needed for at satisfactory spore kill.

The best spore killing performance was obtained with:

[chloride]≦25 mM;
0.1 mM≦[bromide]≦1 mM; and
5 mM≦[ammonium]≦25 mM.

### Example 10

### Killing of Spores at Varying Ratios of Chloride/Bromide/Ammonium; and at Varying Haloperoxidase/Hydrogen Peroxide Concentration

The following reagents were prepared:

DMG buffer (DiMethylGlutamic acid, Sigma D4379), 100 mM, pH adjusted to 7.0 with NaOH;

1×10⁹ Bacillus atrophaeus spores per mL (Bacillus atrophaeus spores: SUS-1-8 Log. Raven Labs, www.Ravenlabs.com);

250 mg/L Haloperoxidase from Curvularia verrucolosa (see WO 97/04102) in MilliQ water;

50 mM Sodium bromide (NaBr) in MilliQ water;

500 mM Sodium chloride (NaCl) in MilliQ water;

200 mM Ammonium chloride (NH₄Cl) in MilliQ water;

25 mM Hydrogen peroxide (H₂O₂) in MilliQ water;

1% (w/v) Sodium thiosulphate (Na₂S₂O₃) in MilliQ water; and

LB plates were made from 37 g LB Agar (Merck 0283) dissolved in 1000 mL water.

Following the methods and principles of the previous Examples, 500 microliters reaction mixture was made using the above mentioned solutions. The reactions were carried out in vials. The final concentrations of the constituents are as shown in Table 17.

TABLE 17

| Haloperoxidase | | NaCl | NH₄Cl | | |
|---|---|---|---|---|---|
| (ppm) | H₂O₂ (mM) | (mM) | (mM) | NaBr (mM) | Vial No. |
| 8 | 2 | 0 | 0 | 0 | 1 |
| | | 0 | 0 | 2 | 2 |
| | | 5 | 5 | 0 | 3 |
| | | 5 | 5 | 2 | 4 |
| | | 10 | 2.5 | 1 | 5 |
| | | 15 | 0 | 0 | 6 |
| | | 15 | 0 | 2 | 7 |
| | | 20 | 5 | 0 | 8 |
| | | 20 | 5 | 2 | 9 |
| 20 | 5 | 2.5 | 2.5 | 1 | 10 |
| | | 7.5 | 0 | 1 | 11 |
| | | 10 | 2.5 | 1 | 12 |
| | | 10 | 2.5 | 0 | 13 |
| | | 10 | 2.5 | 1 | 14 |
| | | 10 | 2.5 | 2 | 15 |
| | | 12.5 | 5 | 1 | 16 |
| | | 17.5 | 2.5 | 1 | 17 |
| 32 | 8 | 0 | 0 | 0 | 18 |
| | | 0 | 0 | 2 | 19 |
| | | 5 | 5 | 0 | 20 |
| | | 5 | 5 | 2 | 21 |
| | | 10 | 2.5 | 1 | 22 |
| | | 15 | 0 | 2 | 23 |
| | | 15 | 0 | 0 | 24 |
| | | 20 | 5 | 2 | 25 |
| | | 20 | 5 | 0 | 26 |

2 × 10⁷ spores
10 mM DMG buffer
MilliQ water ad 500 μL

The ratio of haloperoxidase/hydrogen peroxide was the same that was found to be optimal in Example 6. The reaction was started with addition of hydrogen peroxide. A vial with 10 microliters spore suspension and 490 microliters MilliQ water acted as a control.

The vials were incubated at 60° C. for 30 minutes. The reaction was quenched by addition of 500 microliters sodium thiosulphate, Which was allowed to react for 10 minutes at room temperature.

After that, a dilution series was made in MilliQ water, and 100 microliters from the dilutions 10⁰ to 10⁵ were plated (in duplicate) on LB agar plates. The plates were incubated for 48 hours at 33° C., and the average number of colony forming units/plate (CFU/plate) on each set of plates was registered.

Using the CFU/mL values, the spore kill in log units was calculated, and the results are shown in Table 18.

TABLE 18

| | | | Kill in Log Units | | |
|---|---|---|---|---|---|
| Haloperoxidase | chloride | ammonium | 0 mM | 1 mM | 2 mM |
| (ppm) | (mM) | (mM) | bromide | bromide | bromide |
| 8 | 0 | 0 | 0 | — | 0.7 |
| 8 | 5 | 5 | 1.6 | — | 3.4 |
| 8 | 10 | 2.5 | — | 3.5 | — |
| 8 | 15 | 0 | 3 | — | 0.4 |
| 8 | 20 | 5 | 2.4 | — | 3.6 |
| 20 | 2.5 | 2.5 | — | 3.8 | — |
| 20 | 7.5 | 0 | — | 0.5 | — |
| 20 | 10 | 2.5 | 3.6 | 3.3 | 3.6 |
| 20 | 10 | 5 | — | 3.6 | — |
| 20 | 12.5 | 5 | 3.3 | — | — |
| 20 | 17.5 | 2.5 | — | 3.6 | — |
| 32 | 0 | 0 | 0 | — | 0.1 |
| 32 | 5 | 5 | 4.6 | — | 4.7 |
| 32 | 10 | 2.5 | — | 4.8 | — |
| 32 | 15 | 0 | 2.2 | — | 0.4 |
| 32 | 20 | 5 | 3.1 | — | 3.8 |

The best spore killing performance was obtained with:

[haloperoxidase]=32 ppm;
5 mM≦[chloride]≦20 mM;
0 mM≦[bromide]≦2 mM; and
2.5 mM≦[ammonium]≦5 mM.

### Example 11

### Fungal Spore Production

Trichophyton mentagrophytes ATCC 9233 was cultured on MEA plates and Aspergillus niger ATCC 9642 was grown on MEA slants.

The MEA culture medium was made as follows with deionized water: 30 g/L Malt extract, 3 g/L Soja peptone (papaic digest or soybean meal), agar 15 g/L, pH unadjusted.

Trichophyton mentagrophytes was inoculated at the centre of a MEA Petri dish and incubated at 30° C. for 10-12 days.

The plate was then flooded with M9 buffer with 0.02% Tween 80 and the spores were made into suspension by gently working the mycelial matt with a Drigalski spatula. The cell suspension was then filtered through Miracloth to remove hyphae and the spore number was subsequently determined by counting in a haemocytometer. This spore suspension was used in the experiments.

A slant with vigorous sporulating A. niger was harvested with M9+0.02% Tween and the spore containing liquid filtered through sterile Miracloth to remove hyphae.

The composition of M9 is as follows: In MilliQ water is dissolved 8.77 g/L disodium hydrogen phosphate (Na₂HPO, 2H₂O), 3 g/L potassium dihydrogen phosphate (KH₂PO₄), 4 g/L sodium chloride (NaCl), 0.2 g/L magnesium sulphate (MgSO₄, 7H₂O).

The spore number was subsequently determined by counting in a haemocytometer, and the spore suspension was adjusted to approx. 1×10⁷ spores/mL. This spore suspension was used in the Examples. The spore suspensions were stored at 4° C. for a maximum of 4 days.

### Example 12

### Fungal Spore Kill with System Freshly Prepared Fungal Spores

The following reagents were prepared:

Spore suspension of Aspergillus niger ATCC 9642, 1×10⁷ spores/mL;

Spore suspension of Trichophyton mentagrophytes ATCC 9233, 1×10⁷ spores/mL;

DMG buffer (DiMethylGlutamic acid, Sigma D4379), 100 mM, pH adjusted to 7.0 with NaOH;

100 mg/L Haloperoxidase from Curvularia verrucolosa (see WO 97/04102) in MilliQ water;

50 mM Sodium bromide (NaBr) in MilliQ water;

200 mM Sodium chloride (NaCl) in MilliQ water;

200 mM Ammonium chloride (NH₄Cl) in MilliQ water;

10 mM Sodium percarbonate (2Na₂CO₃.3(H₂O₂)) in MilliQ water; and

YPD plates were made from: 10 g Yeast extract, 20 g Peptone, 20 g Dextrose, 20 g agar, dissolved in 1000 mL water, pH unadjusted.

In vials the reagents were mixed according to Table 19. The spores used were all freshly made (i.e., not stored at 4° C. for any period of time).

TABLE 19

| | T. mentagrophytes | | A. niger | |
|---|---|---|---|---|
| Reagents | Microliters | mM, final | Microliters | mM, final |
| NaCl | 47.5 | 19 | 47.5 | 19 |
| NaBr | 5 | 0.5 | 5 | 0.5 |
| NH₄Cl | 15 | 6 | 15 | 6 |
| DMG buffer | 125 | 25 | 125 | 25 |
| Haloperoxidase | 40 | 8 ppm | 40 | 8 ppm |
| Sodium | 33.5 | 0.67 | 33.5 | 0.67 |
| Percarbonate | | | | |
| Spore suspension | 50 | 1 × 10⁶ | 50 | 1 × 10⁶ |
| H₂O | 184 | — | 184 | — |
| Final volume | 500 | — | 500 | — |

All reagents, except percarbonate, were mixed in a 1.8 mL NUNC cryotube; the spores were added and the experiment started by adding the percarbonate solution.

The tubes were incubated at 40° C. (in a thermo block) for 30 minutes. After 30 minutes incubation, 500 microliters sterile water was added to each tube and 10-fold dilution series were made.

200 microliters from the undiluted sample and 100 microliters from each of the dilutions were plated on YPD plates. The plates were incubated at 30° C. for 2-4 days and CFU/mL calculated.

50 microliters spore suspension added to 450 microliters sterile water with subsequent dilution series, plating 100 microliters/plate and determination of CFU/mL, acted as growth control.

Aspergillus spores are hydrophobic, and it was difficult to get the spores in a homogenous suspension.

Table 20 shows the recorded CFU/plate and the calculated CFU/ml, as well as the spore kill (Log Units).

TABLE 20

| | Trichophyton | | Aspergillus | | Trichophyton | | Aspergillus | |
|---|---|---|---|---|---|---|---|---|
| Dilution | mentagrophytes | | niger | | control | | control | |
| 10⁰ | 0 | 0 | 3 | 15 | — | — | — | — |
| 10⁻¹ | 0 | 0 | 0 | 0 | — | — | — | — |
| 10⁻² | 0 | 0 | 0 | 0 | — | — | — | — |
| 10⁻³ | — | — | — | — | 7 | 13 | 15 | 12 |
| 10⁻⁴ | — | — | — | — | 2 | 3 | 1 | 1 |
| 10⁻⁵ | — | — | — | — | — | — | — | — |

| | | | | |
|---|---|---|---|---|
| CFU/mL | 0 | 9 × 10¹ | 2 × 10⁵ | 1 × 10⁵ |
| Kill | 5 | 3 | — | — |
| (Log Units) | | | | |

The Trichophyton spores were completely inactivated, whereas treatment of the Aspergillus spores resulted in 3 log units reduction in the number of viable spores.

### Example 13

### Fungal Spore Kill on Stored Fungal Spores

The following reagents were prepared:

Spore suspension of Aspergillus niger ATCC9642, 1×10⁷ spores/mL, stored for 2 days at 4° C.;

Spore suspension of Trichophyton mentagrophytes ATCC9233, 1×10⁷ spores/mL, stored for 2 days at 4° C.;

DMG buffer (DiMethylGlutamic acid, Sigma D4379), 100 mM, pH adjusted to 7.0 with NaOH;

100 mg/L Haloperoxidase from Curvularia verrucolosa (see WO 97/04102) in MilliQ water;

50 mM Sodium bromide (NaBr) in MilliQ water;

200 mM Sodium chloride (NaCl) in MilliQ water;

200 mM Ammonium chloride (NH₄Cl) in MilliQ water;

10 mM sodium percarbonate (2Na₂CO₃.3(H₂O₂)) in MilliQ water; and

YPD plates were made from: 10 g Yeast extract, 20 g Peptone, 20 g Dextrose, 20 g agar, dissolved in 1000 mL water, pH unadjusted.

In vials, reagents were mixed according to Table 21.

TABLE 21

| | T. mentagrophytes | | A. niger | |
|---|---|---|---|---|
| Reagents | Microliters | mM, final | Microliters | mM, final |
| NaCl | 142.5 | 19 | 142.5 | 19 |
| NaBr | 15 | 0.5 | 15 | 0.5 |
| NH₄Cl | 45 | 6 | 45 | 6 |
| DMG buffer | 375 | 25 | 375 | 25 |
| Enzyme | 120 | 8 ppm | 120 | 8 ppm |
| Sodium | 100.5 | 0.67 | 100.5 | 0.67 |
| Percarbonate | | | | |
| Spores | 150 | 1 × 10⁶ | 150 | 1 × 10⁶ |
| H₂O | 552 | — | 552 | — |
| Final volume | 1500 | — | 1500 | — |

All ingredients, except percarbonate, were mixed in a 1.8 mL NUNC cryotube, the spores were added and the experiment started by adding the percarbonate solution.

The tubes were incubated at 40° C. (in a thermo block) for 30 minutes. After 30 minutes incubation a 10-fold dilution series was made.

333 microliters from each dilution were plated on YPD plates. The plates were incubated at 30° C. for 2-4 days and CFU/mL calculated.

50 microliters spore suspension added to 450 microliters sterile water with subsequent dilution series, plating 100 microliters/plate and determination of CFU/mL, acted as growth control.

Table 22 shows the recorded CFU/plate and the calculated CFU/ml, as well as the spore kill (Log Units).

TABLE 22

| | | | | | | Trichophyton | | Aspergillus | |
|---|---|---|---|---|---|---|---|---|---|
| | Trichophyton | | Aspergillus | | | growth | | growth | |
| Dilution | mentagrophytes | | niger | | | control | | control | |
| 10⁰ | 0 | 0 | 0 | 0 | 0 | — | — | — | — |
| 10⁻¹ | 0 | 0 | 0 | 0 | 0 | — | — | — | — |
| 10⁻² | 0 | 0 | 0 | 0 | 0 | — | — | — | — |
| 10⁻³ | — | — | — | — | — | — | — | — | — |
| 10⁻⁴ | — | — | — | — | — | 6 | 3 | 3 | 3 |
| 10⁻⁵ | — | — | — | — | — | 0 | 1 | 0 | 1 |

| | | | | |
|---|---|---|---|---|
| CFU/mL | 0 | 0 | 5 × 10⁵ | 5 × 10⁵ |
| Kill | 5 | 5 | — | — |
| (Log Units) | | | | |

Treatment of both Trichophyton and Aspergillus spores resulted in at least 5 log units reduction in the number of viable spores.

### Example 14

### Killing of Bacillus subtilis Spores on Polyester Sutures

The following reagents were prepared:

DMG buffer (DiMethylGlutamic acid, Sigma D4379), 50 mM, pH adjusted to 7.0 with NaOH;

Phosphate buffer, 100 mM, pH adjusted to 7.0 with NaOH;

200 mg/L Haloperoxidase from Curvularia verrucolosa (see WO 97/04102) in 50 mM DMG buffer;

400 mM Sodium chloride (NaCl) in MilliQ water;

200 mM Ammonium chloride (NH₄Cl) in MilliQ water;

40 mM Hydrogen peroxide (H₂O₂) in MilliQ water;

10% Sodium thiosulphate (Na₂S₂O₃);

Synthetic hard water at 40° dH; and

200× dilution of a commercial non-ionic surfactant.

### Other Materials:

tubes containing 5 mL of 1% Tween 80 in water and approximately 1 mL glass beads (3 mm diameter);

LB plates were made from 37 g LB Agar (Merck 0283) dissolved in 1000 mL water;

Nunc Cryo Tubes;

Adjustable heating block; and

Polyester sutures coated with 10⁶ Bacillius subtilis ATCC 19659 spores (Presque Isle Cultures, catalog #SP-BS) were used for the experiment (one suture was used for one treatment).

In a Nunc Cryo tube the following components were mixed:

50 microliters Phosphate buffer,
12.5 microliters NaCl solution,
25 microliters NH₄Cl solution,
160 microliters Haloperoxidase solution,
500 microliters Synthetic hard water 40° dH,
15.4 microliters 200× diluted non ionic surfactant,
37.1 microliters MilliQ water, and
One Bacillus subtilis spore coated polyester suture (10⁶ spores).

A negative control was prepared as above, but with the haloperoxidase solution substituted with MilliQ water.

The reactions were subsequently started by the addition of 200 microliters Hydrogen peroxide.

The vials were incubated at 40° C. for 20 minutes. To stop the reaction 500 microliters Sodium thiosulphate was added, and incubated for 10 minutes at room temperature (approximately 23° C.). Each suture was then transferred to a tube containing 1% Tween 80 in water and glass beads, and the tubes were shaken for 15 minutes at 300 rpm to recover the remaining spores.

After that a dilution series was made in MilliQ water, and 100 microliters from the dilutions 10⁰ to 10⁻³ were plated on LB agar plates (14 cm plates). The plates were incubated for 48 hours at 37° C., and the average number of colony forming units (CFU) on each plate was registered.

The number of colonies was used to calculate the log reduction (kill) in number of recoverable bacteria, which is shown in Table 23.

TABLE 23

| | Log reduction (Log Units) |
|---|---|
| Negative control | 0 |
| Treated | >6 |
| Number of recovered spores | 1.5 × 10⁶ spores/suture |
| from control suture | |

The result shown in Table 23 demonstrates that the haloperoxidase solution of the invention has a clear and significant sporicidal effect effect compared to a negative control. The number of spores able to germinate after the treatment with the haloperoxidase was reduced 6 log units in 90 min.

### Example 15

### Disinfection of Bacillus atrophaeus Spores on a Stainless Steel Carrier

The following reagents were prepared:

DMG buffer (DiMethylGlutamic acid, Sigma D4379), 50 mM, pH adjusted to 7.0 with NaOH;

200 mg/L Haloperoxidase from Curvularia verrucolosa (see WO 97/04102) in 50 mM DMG buffer;

400 mM Sodium chloride (NaCl) in MilliQ water;

100 mM Ammonium sulphate ((NH₄)₂SO₄) in MilliQ water;

10 mM Hydrogen peroxide (H₂O₂) in MilliQ water;

50 mM Sodium bromide (NaBr) in MilliQ water; and

5% Sodium thiosulphate (Na₂S₂O₃).

Other Materials:

tubes containing 5 mL of 1% Tween 80 in water and approximately 1 mL glass beads (3 mm diameter);

LB plates were made from 37 g LB Agar (Merck 0283) dissolved in 1000 mL water;

Nunc Cryo Tube;

Adjustable heating block; and

Stainless steel discs each containing 10⁶ Bacillus atrophaeus spores (Raven Labs cat. #1-6100ST, ATCC 9372) were used for the experiment (one disc was used for one treatment).

In a Nunc Cryo tube the following components were mixed:

478 microliters DMG buffer,
7.5 microliters NaBr (Substituted with DMG buffer in experiment without NaBr)
47 microliters NaCl solution,
38 microliters (NH₄)₂SO₄ solution,
30 microliters Haloperoxidase solution, and
One Bacillus atrophaeus spore disc (10⁶ spores).

To test the effect of sodium bromide on the kill efficacy experiments were done both with and without NaBr. In the latter experiments NaBr was substituted with DMG buffer.

A negative control was prepared as above but with the haloperoxidase solution substituted with DMG buffer.

The reactions were subsequently started by the addition of 150 microliters Hydrogen peroxide. The vials were incubated at 40° C. for 20 minutes. To stop the reaction 750 microliters Sodium thiosulphate was added, and incubated for 10 minutes at room temperature (approximately 23° C.). Each disc was then transferred to a tube containing 1% Tween 80 in water and glass beads, and the tubes were shaken for 15 minutes at 300 rpm to recover the remaining spores.

After that a dilution series was made in MilliQ water, and 100 microliters from the dilutions 10⁰ to 10⁻³ were plated on LB agar plates (14 cm plates) The plates were incubated for 48 hours at 37° C., and the average number of colony forming units (CFU) on each plate was registered.

The number of colonies was used to calculate the log reduction (kill) in number of recoverable bacteria, which is shown in Table 24.

TABLE 24

| | Log reduction (Log Units) |
|---|---|
| Negative control | 0 |
| Treated (without NaBr) | 1 |
| Treated (with NaBr) | >3 |
| Number of recovered spores | 10⁵ spores/suture |
| from control cylinder | |

1-24. (canceled)

25. A method for killing or inactivating microbial spores, which comprises contacting the spores with a haloperoxidase, hydrogen peroxide, chloride or bromide ions, and ammonium ions.

26. The method of claim 25, wherein the haloperoxidase is a chloroperoxidase from enzyme class EC 1.11.1.10.

27. The method of claim 25, wherein the haloperoxidase is a vanadium containing haloperoxidase.

28. The method of claim 27, wherein the amino acid sequence of the haloperoxidase has at least 90% identity to the amino acid sequence of a Curvularia verruculosa or Curvularia inequalis haloperoxidase.

29. The method of claim 25, wherein the chloride or bromide ions are derived from sodium chloride, sodium bromide, potassium chloride, potassium bromide, ammonium chloride or ammonium bromide; or a mixture thereof.

30. The method of claim 25, wherein the ammonium ions are derived from ammonium sulphate, ammonium carbonate, ammonium phosphate, ammonium chloride, ammonium bromide or ammonium iodide; or a mixture thereof.

31. The method of claim 25, wherein the concentration of chloride ions is at least two times higher than the concentration of ammonium ions.

32. The method of claim 25, which further comprises contacting the spores with a surfactant.

33. The method of claim 25, wherein the microbial spores are fungal or bacterial spores.

34. The method of claim 25, wherein the spores are located on a surface, such as a textile surface or a surface of laboratory or process equipment or a medical device.

35. The method of claim 25, wherein the spores are contacted with chloride and bromide ions.

36. A composition comprising a haloperoxidase, hydrogen peroxide, chloride or bromide ions, ammonium ions and a medical device.

37. A method for disinfecting or sterilizing a device, comprising contacting the device with a haloperoxidase, hydrogen peroxide, chloride or bromide ions, and ammonium ions.
